(19) United States
(12) Patent Application Publication
(10) Pub. No.: US 2009/0074541 A1
(43) Pub. Date: Mar. 19, 2009

(54) BOOKBINDING SYSTEM AND BOOKBINDING APPARATUS

(76) Inventor: Takashi YAMASHITA, Tokyo (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/046,248

(22) Filed: Mar. 11, 2008

(30) Foreign Application Priority Data
Sep. 18, 2007 (JP) JP2007-240676

(51) Int. Cl. B42C 13/00; B42C 9/00

(52) U.S. Cl. 412/14

(57) ABSTRACT

A bookbinding system to produce plural booklets includes: a bookbinding apparatus which forms a sheet bundle by stacking plural sheets on each of which an image has been formed by an image forming apparatus, and joins a spine of the sheet bundle and a cover sheet with an adhesive; a coating section which applies the adhesive onto the spine of the sheet bundle; a measuring section which measures a thickness of the sheet bundle; a calculating section which calculates at least an amount of the adhesive applied onto the spine, or charge information corresponding to the amount of the adhesive applied, on the basis of thickness information of the sheet bundle measured; and a first accumulating section which carries out at least an accumulating operation that accumulates the amount of adhesive calculated, or an accumulating operation that accumulates the charge information calculated.

This application is based on Japanese Patent Application No. 2007-240676 filed on Sep. 18, 2007, which is incorporated hereinto by reference.

### BACKGROUND OF THE INVENTION

The present invention relates to a bookbinding system and a bookbinding apparatus in which a plurality of sheets are stacked to form a sheet bundle, and a cover sheet is adhered onto the sheet bundle so that a printed booklet is formed.

In image forming apparatuses, such as copy machines and printers, various kinds of devices have been proposed in which the charge of the printed booklet produced by the devices is calculated based on the printed results, and which is charged to the user.

For example, after printing or copying is completed, the devices calculate the fee for each of the printed sheets based on size to charge the fee to the user, or the devices count the number of color prints or the number of monochromatic prints, on which a prescribed unit price is multiplied to charge to the users.

A technology in Unexamined Japanese Patent Application Publication No. 11-184,336 is that the fee for a single page is counted based on the outputted states (which are black-white printing, monochromatic printing, and full color printing) and the size of sheet, whereby the determined fee for the outputted sheets is charged to the user. According to the technology, an appropriate charge can be conducted, based on the practical output state and the size of the sheets.

An adhesive is typically used for each binding operation of the bookbinding systems or the bookbinding apparatuses, in which a plurality of sheets, carrying an image formed by the image forming apparatus, are stacked to form a sheet bundle, and the sheet bundle is joined to a cover sheet to form a booklet. Accordingly, the amount of adhesive can also be charged as the fee to the user, however, a technology to charge the fee of the adhesive has never been shown. The charge calculating method of the amount of adhesive used for bookbinding is now being studied, based on the number of booklets outputted by the bookbinding system.

An example of a booklet produced by the bookbinding system is shown in FIGS. 13(a) and 13(b). FIG. 13(a) shows a state in which a cover sheet S2 is not folded, while FIG. 13(b) shows a state in which a cover sheet S2 is folded.

Booklet S3 is structured of a bundle of sheets S1 and cover sheet S2. After the adhesive is applied onto spine SSE of the bundle of sheets S1, cover sheet S2 is folded to be a U-shape to enclose the bundle of sheets S1. In a state of completed booklet S3, edge S1E of sheet S1 has been aligned to edge S2E of cover sheet S2.

The amount of the adhesive used for making a single booklet is obtained based on the area of spine SSE, which is thickness X of the sheet bundle times size Y of sheet S1. Though size Y of sheet S1 can be precisely known by information set by the user, thickness X of the sheet bundle depends on various characteristics, (for example, curling of sheet S1), so that it is sometimes not possible to precisely obtain thickness X by simple calculation, (for example, the multiplication of the thickness of a single sheet and the number of sheets included in the sheet bundle). Accordingly, if the charge is calculated by the simple calculation, the user is not correctly charged for the booklet.

Further, in order to obtain the outputted results of the booklets, the user wants to precisely know the total of thickness X of the sheet bundles, based on the outputted booklets. Still further, the user may want to know accumulated copies, by each size of thickness X of the sheet bundle.

### SUMMARY OF THE INVENTION

A bookbinding system relating to the present invention includes: an image forming apparatus which forms an image on a sheet; a bookbinding apparatus which forms a sheet bundle by stacking a plurality of sheets on each of which the image has been formed by the image forming apparatus, and joins a spine of the sheet bundle and a cover sheet with an adhesive, thereby produces a booklet; a coating section which applies the adhesive onto the spine of the sheet bundle; a measuring section which measures a thickness of the sheet bundle; a calculating section which calculates at least an amount of the adhesive that has been applied onto the spine of the sheet bundle by the coating section, or charge information corresponding to the amount of the adhesive applied onto the spine, on the basis of thickness information of the sheet bundle measured by the measuring section; and a first accumulating section which carries out at least an accumulating operation that accumulates the amount of adhesive calculated by the calculating section, or an accumulating operation that accumulates the charge information calculated by the calculating section, when a plurality of booklets are produced.

Further, another bookbinding system relating to the present invention includes: an image forming apparatus which forms an image on a sheet; a bookbinding apparatus which forms a sheet bundle by stacking a plurality of sheets on each of which the image has been formed by the image forming apparatus, and joins a spine of the sheet bundle and a cover sheet with an adhesive, thereby produces a booklet; a measuring section which measures a thickness of the sheet bundle; and a second accumulating section which carries out at least an accumulating operation which accumulates thickness information of the sheet bundle that has been outputted, or an accumulating operation of the number of outputted booklets for each size of thickness, which is classified with respect to the thickness information of the sheet bundle, on the basis of the thickness information measured by measuring section.

Yet another bookbinding apparatus relating to the present invention joins a cover sheet onto a spine of a sheet bundle including a plurality of sheets, to produce a booklet, wherein the bookbinding apparatus includes: a coating section which applies the adhesive onto the spine of the sheet bundle; a measuring section which measures a thickness of the sheet bundle; a calculating section which calculates at least an amount of the adhesive that has been applied onto the spine of the sheet bundle by the coating section, or charge information corresponding to the amount of the adhesive applied onto the spine, on the basis of thickness information of the sheet bundle measured by the measuring section; and a first accumulating section which carries out at least an accumulating operation that accumulates the amount of adhesive calculated by the calculating section, or an accumulating operation that accumulates the charge information calculated by the calculating section, when a plurality of booklets are produced.

Still yet another bookbinding apparatus relating to the present invention joins a cover sheet onto a spine of a sheet bundle, including a plurality of sheets, to produce a booklet, wherein the bookbinding apparatus includes: a measuring section which measures a thickness of the sheet bundle; and a second accumulating section which carries out at least one of an accumulating operation which accumulates thickness information of the sheet bundle that has been outputted, or an accumulating operation of the number of outputted booklets for each size of thickness, which is classified with respect to the thickness information of the sheet bundle, on the basis of the thickness information measured by measuring section.

### BRIEF DESCRIPTION OF THE DRAWINGS

FIG. 1 is a central cross sectional view of the bookbinding system.

FIG. 2 is a block diagram to show a control system of the bookbinding system.

FIG. 3 is a front cross sectional view of the bookbinding apparatus.

FIGS. 4(a)-4(d) show the process to apply adhesive onto the sheet bundle.

FIGS. 5(a)-5(b) show the operation to apply the adhesive by an adhesive applying section.

FIGS. 6(a)-6(c) show the process to join the cover sheet onto the spine.

FIG. 7 is a flow chart to show the operation for measuring the thickness of the sheet bundle.

FIGS. 8(a)-8(d) show the operation of a first interposing member and a second interposing member.

FIG. 9 is a flowchart for calculating a coating amount of adhesive, and calculating charge information, within the image forming apparatus.

FIG. 10 shows a displayed example, displayed on an operating and displaying section of the image forming apparatus.

FIG. 11 is a flow chart for accumulating the thickness of the sheet bundles which have been outputted by the image forming apparatus.

FIG. 12 shows a displayed example, displayed on the operating and displaying section of the image forming apparatus.

FIGS. 13(a)-13(b) show a booklet which is outputted by the bookbinding apparatus.

### DETAILED DESCRIPTION OF THE PREFERRED EMBODIMENT

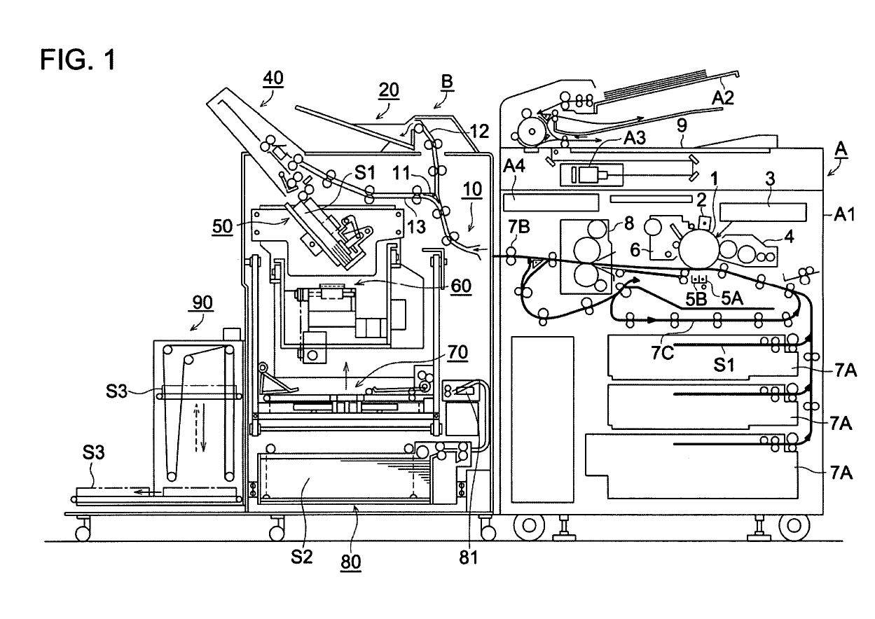

FIG. 1 is a central cross sectional view of the bookbinding system relating to the present invention.

The bookbinding system relating to the present invention includes image forming apparatus A and bookbinding apparatus B.

Image forming apparatus A, which forms an image on a sheet by the electro-photographic method, includes image forming section A1, original document conveying device A2, image reading section A3, and communicating section A4. Charging unit 2, imagewise exposing unit 3, developing unit 4, transferring unit 5A, separating unit 5B, and cleaning unit 6 are arranged around photoconductive drum 1 of image forming section A1, whereby processes are conducted for electrical charging, exposure, development and image transferring, to form a toner image on sheet S1. Varying sizes of sheets S1 are stored in three sheet feeding trays 7A, and sheets S1 are ejected from sheet feeding tray 7A one by one to be conveyed to image forming section A1. Sheet S, carrying the toner image, is conveyed to fixing unit 8 to be fixed. Fixed sheet S1 is ejected outside of image forming apparatus A through paired sheet ejection rollers 7B, or conveyed to sheet re-feeding path 7C.

Image forming apparatus A of the present invention forms monochrome images on sheet S1 by the electro-photographic method, however, the image forming apparatus of the present invention is not limited to the embodiments described below, a color image forming apparatus may also be used, and the image forming method is not limited to the electro-photographic method, and other than the electro-photographic method may also be used.

Bookbinding apparatus B forms a sheet bundle of a plurality of sheets S1 sent from image forming apparatus A, and applies a cover sheet to enclose the sheet bundle, to generate a booklet. Bookbinding apparatus B includes sheet reversing section 40, stacking section 50, coating section 60, and joining section 70 to join the cover sheet onto the sheet bundle, and bookbinding apparatus B further includes conveyance section 10, sheet ejection tray 20, cover sheet storing section 80, and booklet ejecting section 90.

Sheet S1, conveyed from image forming apparatus A to bookbinding apparatus B, is ejected onto sheet ejection tray 20 through ejection path 12, or conveyed to sheet reversing section 40, by switching gate 11 mounted on conveyance section 10. When sheet S1 is not to be bound by bookbinding apparatus B, the sheet S1 is ejected directly onto sheet ejection tray 20.

When sheet S1 is to be bound by bookbinding apparatus B, sheet S1 is conveyed to sheet reversing section 40 through conveying path 13, where sheet S1 is switched back, and conveyed to stacking section 50. After sheets S1 have been stacked to a prescribed number on stacking section 50, stacking section 50 rotates to vertically support a bundle of sheets S1. Adhesive is applied onto the spine of the bundle of sheets S1 which faces downward, by coating section 60, then cover S2 touches the bundle of sheets S1, and joining section 70 joins cover sheet S2 onto the bundle of sheets S1. Booklet S3, representing the bundle of sheets S1 enclosed with cover sheet S2, is ejected onto booklet ejecting tray 90.

In addition, although not shown in FIG. 1, it is also possible to provide a tray on bookbinding apparatus B, to stack individual sheets or sheet bundles, to be bound, and to operate the bookbinding apparatus B as a single apparatus, so that booklet S3 is produced.

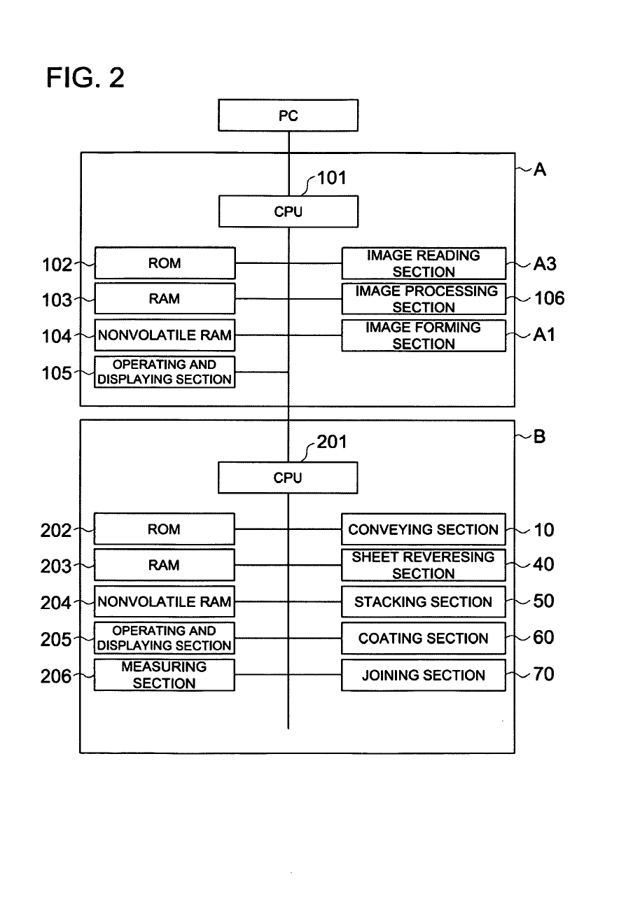

FIG. 2 is a block diagram to show a control system of the bookbinding system, in which typical sections are listed.

A personal computer serving as a terminal device and bookbinding apparatus B are connected to image forming apparatus A.

CPU 101 (which is a Central Processing Unit), which controls the total functions of image forming apparatus A, is connected to ROM 102 (which is a Read Only Memory), RAM 103 (which is a Random Access Memory), and the like. The CPU 101 reads out various control programs stored in ROM 102, and develops them onto RAM 103 to operate the various sections. Further, CPU 101 conducts the various processes in accordance with the programs developed on RAM 103, and stores the processed results in RAM 103. CPU 101 further stores the processed results stored in RAM 103 into prescribed storing sections.

ROM 102 previously stores the programs and various data, ROM 102 is typically structured of a semi-conductor memory.

RAM 103 forms a working area in which the data, processed by the various programs conducted by CPU 101, is temporarily stored.

Nonvolatile RAM 104 temporarily stores the processed data, and even when image forming apparatus A is electrically deactivated, the data in nonvolatile RAM 104 is not deleted.

Operating and displaying section 105, serving as a display section, receives various setting works. For example, operating and displaying section 105 has a touch-panel, whereby the user touches it to set the conditions for forming the image. Further, operating and displaying section 105 displays information concerning the settings of a network, as well as various other information.

The image data generated by image reading section A3, and the image data sent from the personal computer connected to image forming apparatus A, are processed by image processing section 106. Image forming section A1 receives the image data processed by image processing section 106, and forms the image on sheet S1.

CPU 201 of bookbinding apparatus B controls the total operations of bookbinding apparatus B, and further conducts the bookbinding process at a prescribed time, based on signals sent from image forming apparatus A. CPU 201 reads out various control programs stored in ROM 202, and develops them onto RAM 203, to operate coating section 60, joining section 70, and the like.

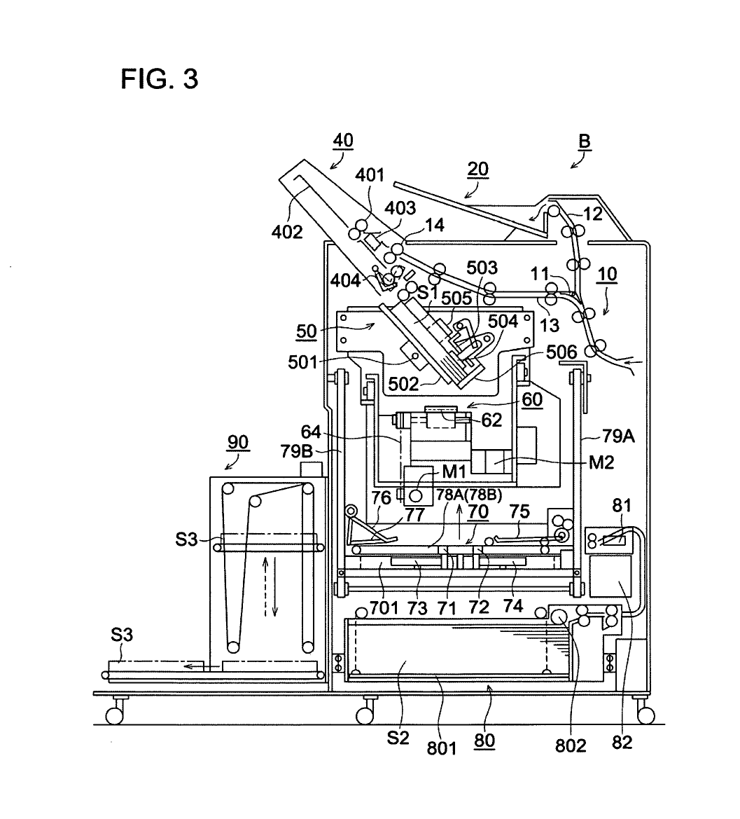

FIG. 3 is a front cross sectional view of bookbinding apparatus B.

Sheet S1, conveyed through conveying path 13, is temporarily ejected onto reversing guide 402 through paired ejection rollers 14 and paired conveyance rollers 401. Sheet S1 on reversing guide 402 is aligned perpendicular to the sheet conveyance direction by aligning member 403, and is temporarily stacked by the motion of stopper 404. Stopper 404 can move between the position shown by solid lines and the position shown by dotted lines. While the bundle of foregoing sheets S1 exists on stacking section 50, stopper 404 moves to the dotted position so that succeeding sheet S1 can be temporarily stacked on reversing guide 402. After the bundle of foregoing sheets S1 is ejected from stacking section 50, stopper 404 moves to the position shown by the solid lines, so that sheet S1, which was temporarily stacked, drops onto stacking section 50. Since the stacking section 50 includes first interposing member 502 and receiving plate 506, sheet S1 can be supported in the oblique state by first interposing member 502 and receiving plate 506. Sheet S1, supported in the oblique state, is pushed by pushing member 504, so that sheet S1 is prevented from moving upward, and is aligned by aligning plate 505. Subsequently, second interposing member 503 is driven to support the bundle of sheets S, and stacking section 50, which is supporting the bundle of sheets S1, pivots on shaft 501, so that the bundle of sheets S1 turns to a vertical state from the oblique state.

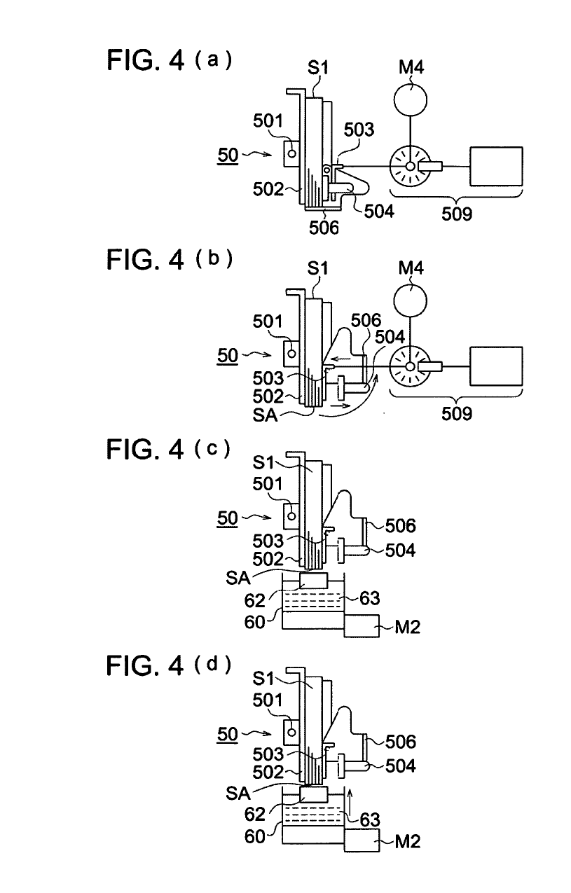

FIGS. 4(a)-4(d) show the process to apply adhesive onto the bundle of sheets S1.

As shown in FIG. 4(a), motor M4 drives second interposing member 503 to move toward sheets S1, so that second interposing member 503 presses sheets S1 at a predetermined pressure, and a driving torque detecting sensor (which is not illustrated) detects the increase of the driving torque of motor M4, whereby motion of second interposing member 503 is stopped. By this structure, the bundle of sheets S1 is firmly supported by first interposing member 502 and second interposing member 503. The amount of motion of second interposing member 503 is measured by encoder 509, which value is then stored in non-volatile RAM 204.

When the bundle of sheets S1 has been supported by first interposing member 502 and second interposing member 503, receiving plate 506 is rotated 90° by a driving mechanism (which is not illustrated), so that receiving plate 506 is retreated as shown FIG. 4(b). In this condition, lower surface SA of sheets S1 is separated from coating roller 62 (see FIG. 4(c)).

As shown in FIG. 4(d), coating section 60, which stores adhesive 63, moves upward so that coating roller 62 comes into contact with lower surface SA which is a spine of the bundle of sheets S1, after which coating section 60 moves along lower surface SA of the bundle of sheets S1, to apply adhesive 63 onto lower surface of the bundle of sheets S1.

A roller is used as a means for applying adhesive onto the spine in this embodiment, if the effect of the invention is not lost, a belt or a brush can also be used. As a coating member to be used, a roller is preferable for use, because a roller more evenly applies melted adhesive onto the spine.

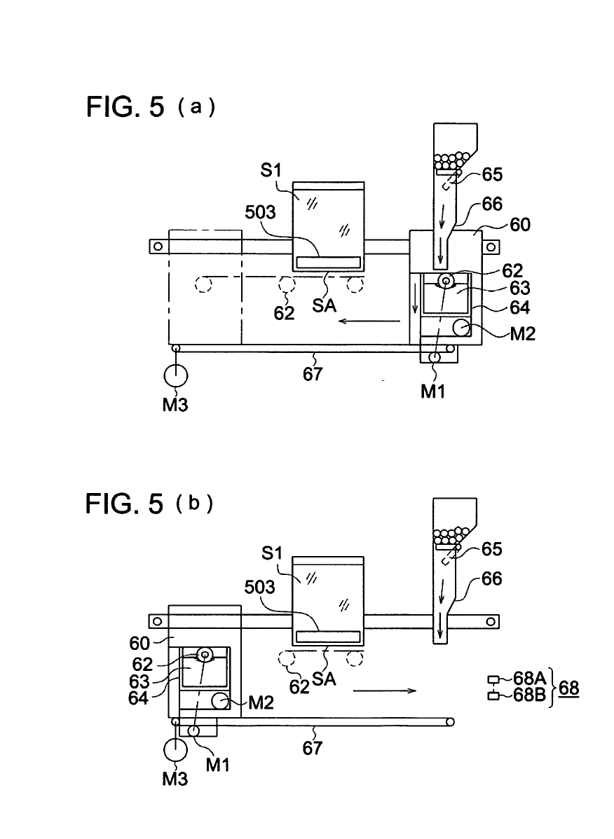

The operation to apply adhesive 63 conducted by coating section 60 will now be detailed while referring to FIGS. 5(a)-5(b).

Coating section 60 includes coating roller 62 which coats the spine of the bundle of sheets S1 with adhesive 63, adhesive 63, adhesive storing section 64 which stores adhesive 63, and an un-illustrated heater which melts solid adhesive 63. Solid adhesive 63 is stored in adhesive container 66. When the amount of remaining melted adhesive 63 becomes lower, movable member 65 moves to supply solid adhesive 63 to coating section 60. The heater in coating section 60 heats solid adhesive 63, whereby solid adhesive 63 is melted in coating section 60.

At a starting state of the bookbinding process, coating section 60 is positioned at the right position in FIG. 5(a), which is an initial position. The right position represents the rear of bookbinding apparatus B, that is, in the depth direction of FIG. 1. Position detecting sensor 68, incorporating light emitting element 68A and light receiving element 68B, is mounted at the right position of FIG. 5(a). When position detecting sensor 68 detects that a portion of coating section 60 exists between light emitting element 68A and light receiving element 68B, it is determined that coating section 60 is in the initial position. When the bookbinding process is started, coating section 60 moves from the right position to the left position (in the front direction of bookbinding apparatus B) in FIG. 5(a). This movement is conducted by belt 67 driven by motor M3. During the process of coating section 60 moving from the right position to the left position, coating roller 62 does not contact the lower surface SA of the bundle of sheets S1. In FIG. 5(b), when coating section 60 begins to move from the left position to the right position, coating roller 62 is lifted by motor M2, so that coating roller 62 contacts lower surface SA of the bundle of sheets S1 to apply adhesive 63. Coating roller 62 moves to trace dashed circles shown in FIGS. 5(a) and 5(b), while being rotated by motor M1 to apply adhesive 63 onto lower surface SA of the bundle of sheets S1.

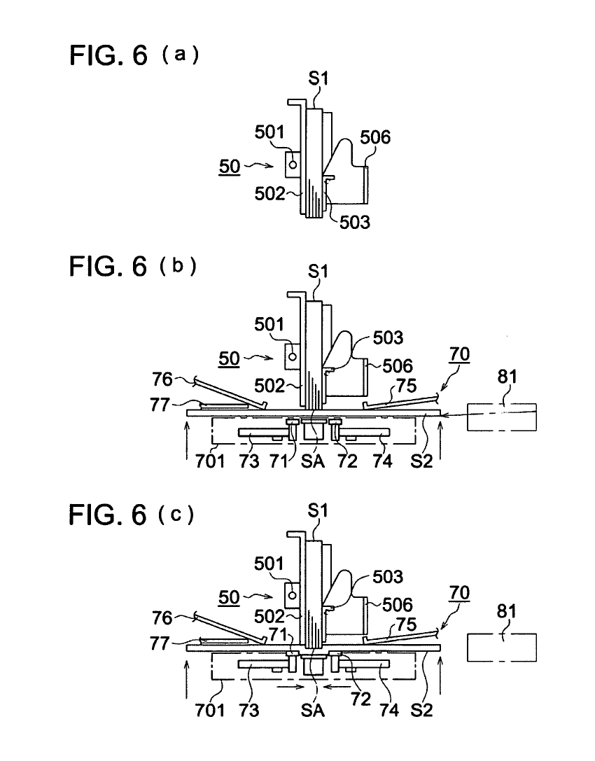

FIGS. 6(a)-6(c) show the process to join cover sheet S2 onto spine SA.

As shown in FIG. 3, cover sheets S2 are stored in sheet feed tray 801 of cover sheet storing section 80 mounted at the lower section of bookbinding apparatus B, whereby cover sheet S2 is ejected by sheet feed roller 802. The ejected cover sheet S2 is trimmed by cutter 81 to the appropriate length, and is placed horizontally on cover sheet supporting member 701. Cover sheet supporting member 701, shown by the chained lines in FIGS. 6(b) and 6(c), is structured of pressing members 71 and 72, and cams 73 and 74 which drive pressing members 71 and 72. Cutter 81 trims cover sheet S2 to the predetermined length which is based on information of the size of sheet S1 and information of the thickness of the bundle of sheets S1.

FIG. 6(a) shows a state in which adhesive 63 has already been applied onto the spine. In the state shown by FIG. 6(a), cover sheet supporting member 701 supports cover sheet S2 at the lower position which is separated from the lower surface of the bundle of sheets S1, which is shown in FIG. 3.

Next, cover sheet supporting member 701 is driven by belts 79A and 79B to go up, which is shown in FIG. 6(b), whereby cover sheet S2 comes into contact with lower surface SA of the bundle of sheets S1, which represents the surface to be coated with adhesive 63. Cover sheet pressing members 75, 76 and 77 go up and down with cover sheet supporting member 701. Accordingly, when cover sheet supporting member 701 has completely risen, as shown in FIG. 6(b), cover sheet pressing members 75, 76 and 77 press cover sheet S2 from above, to support cover sheet S2 in a horizontal condition.

Cover sheet supporting member 701 further rises several mm from the position shown in FIG. 6(b). FIG. 6(c) shows the position risen several mm. Pressing members 71 and 72 press cover sheet S2 from the left side and the right side, respectively, that is, cover sheet S2 is folded at the border of a spine cover sheet and a cover sheet, and at the border of the spine cover sheet and a rear cover sheet. Accordingly, cover sheet S2 is closely overlapped onto the bundle of sheets S1, whereby booklet S3 is produced.

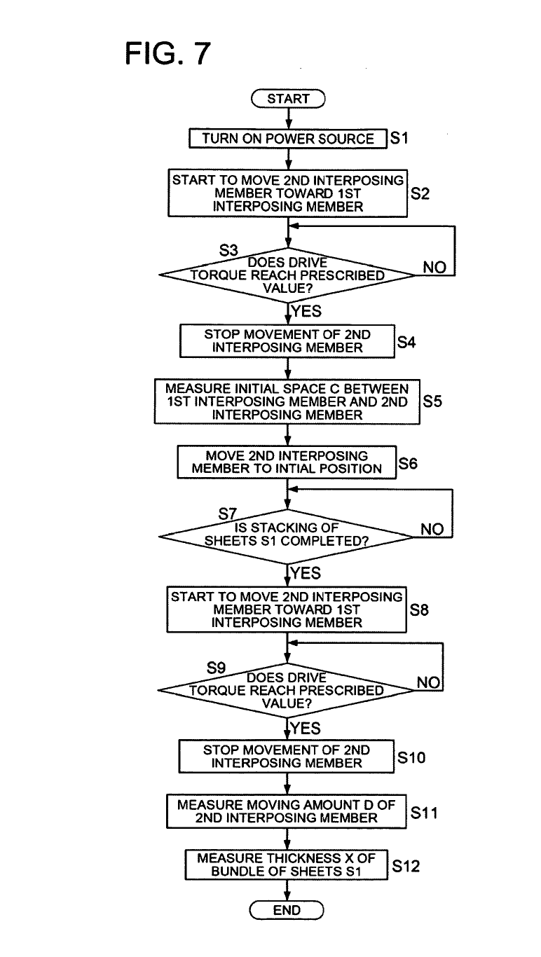

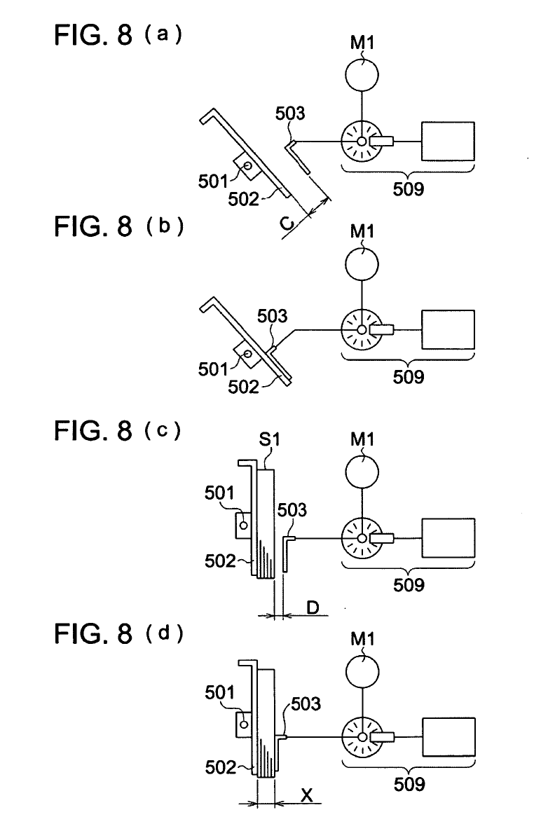

When bookbinding apparatus B generates booklets S3, adhesive 63 in coating section 60 is consumed, so that it is desired to charge an appropriate fee to the user, after determining the amount of consumed adhesive 63. In order to correctly measure the amount of adhesive consumed by a single booklet, the thickness of the bundle of sheets S1 must be measured, which will be detailed while referring to FIG. 7 and FIGS. 8(a)-8(d).

FIG. 7 is a flow chart to show the operation to measure the thickness of the bundle of sheets S1, while FIGS. 8(a)-8(d) show the operation of first interposing member 502 and second interposing member 503. In order to more clearly explain the measuring method via FIGS. 8(a)-8(d), unimportant sections are not illustrated.

FIG. 8(a) shows the state in which the bundle of sheets S1 is not stacked between first interposing member 502 and second interposing member 503, and both interposing members are in an oblique orientation. Further, second interposing member 503 exists at an initial position. In this state, initial space C which is between first interposing member 502 and second interposing member 503 is measured.

Firstly, when bookbinding apparatus B of the bookbinding system is powered on, (step S1 in FIG. 7), the program to measure initial space C is read out from RAM 203, and CPU 201 conducts the measuring operation. CPU 201 activates motor M1 to move second interposing member 503 toward first interposing member 502 (step S2 in FIG. 7). A driving torque detecting sensor, which is not illustrated, detects whether the driving torque of motor M1 reaches a prescribed value (step S3 in FIG. 7).

When it is detected that the driving torque of motor M1 has reached a prescribed value, CPU 201 stops the movement of second interposing member 503 (step S4 in FIG. 7). When the movement of second interposing member 503 is completely stopped, first interposing member 502 and second interposing member 503 are in contact as shown in FIG. 8(b). Since encoder 509 measures the amount of motion of second interposing member 503, the moving amount represents initial space C which is between first interposing member 502 and second interposing member 503 (step S5 in FIG. 7). CPU 201 stores value of initial space C in RAM 203.

After the measurement of initial space C is completed, second interposing member 503 is moved toward the initial position to stack the bundle of sheets S1 (step S6 in FIG. 7).

When the specified number of sheets S1 are completely stacked (step S7 in FIG. 7), first interposing member 502 and second interposing member 503 pivot about shaft 501, while maintaining initial clearance C, so that they move from the oblique state to the vertical state. The thickness of the bundle of stacked sheets S1 is measured by measuring section 206 of bookbinding apparatus B. Measuring section 206 is structured of first interposing member 502, second interposing member 503, motor M1, the driving torque detecting sensor, and encoder 509 which detects the amount of motion of second interposing member 503.

Firstly, second interposing member 503 is moved toward first interposing member 502 (step S8 in FIG. 7), the driving torque detecting sensor detects whether the driving torque of motor M1 reaches the prescribed value (step S9 in FIG. 7).

When the prescribed value is detected for the driving torque of motor M1, second interposing member 503 is stopped to move (step S10 in FIG. 7). When second interposing member 503 has completely stopped, second interposing member 503 contacts sheet S1, as shown in FIG. 8(d). The amount of motion of second interposing member 503 (which is represented by D in FIG. 8(c)) has been measured by encoder 509 (step S11 in FIG. 7).

Subsequently, CPU 201 reads out the initial value of space C from RAM 203, whereby a difference between initial space C and moving amount D implies measured thickness X of the bundle of stacked sheets S1 (step S12 in FIG. 7). Accordingly, the bundle of stacked sheets S1 is directly interposed between first interposing member 502 and second interposing member 503, whereby thickness X of the bundle of stacked sheets S1 is correctly measured.

According to the measuring method shown in FIGS. 8(a)-8(d), second interposing member 503 is moved by motor 503 to measure thickness X of the bundle of stacked sheets S1. Otherwise, it is possible to measure thickness X in such a way that first interposing member 502 is moved instead of moving second interposing member 503. Further, it is also possible that both first and second interposing members 502 and 503 are connected to motors and encoders, and both first and second interposing members 502 and 503 are moved to measure thickness X of the bundle of stacked sheets S1.

Next, the operation for calculating the coating amount of adhesive will be detailed, while using the above measured thickness of the bundle of the stacked sheets, which was detailed by FIG. 7 and FIGS. 8(a)-8(d).

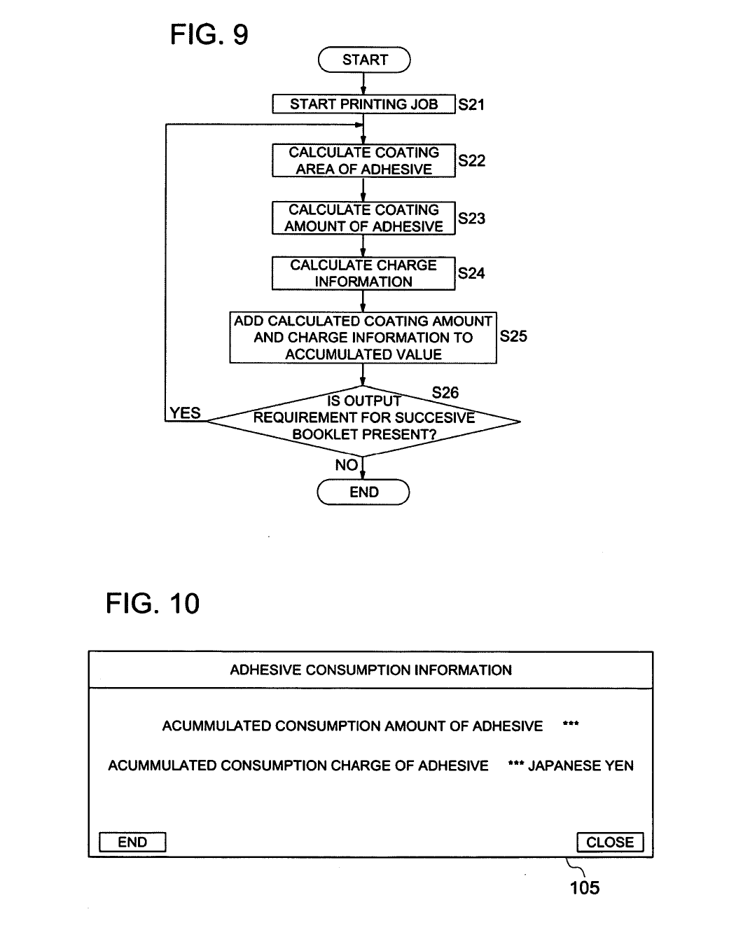

FIG. 9 is a flow chart for calculating the coating amount of adhesive 63, and calculating charge information, within image forming apparatus A.

The outline of the operation shown in FIG. 9 is that steps S22-S24 show calculation of the coating amount of adhesive, as well as the calculation of the charge information, and step S25 shows that the calculated values are added to the total value.

Firstly, image forming apparatus A starts the printing job, which was set by operation display section 105, to form a booklet, or image forming apparatus A starts the printing job, which was received by the personal computer serving as an external terminal, to form a booklet (step S21 in FIG. 9).

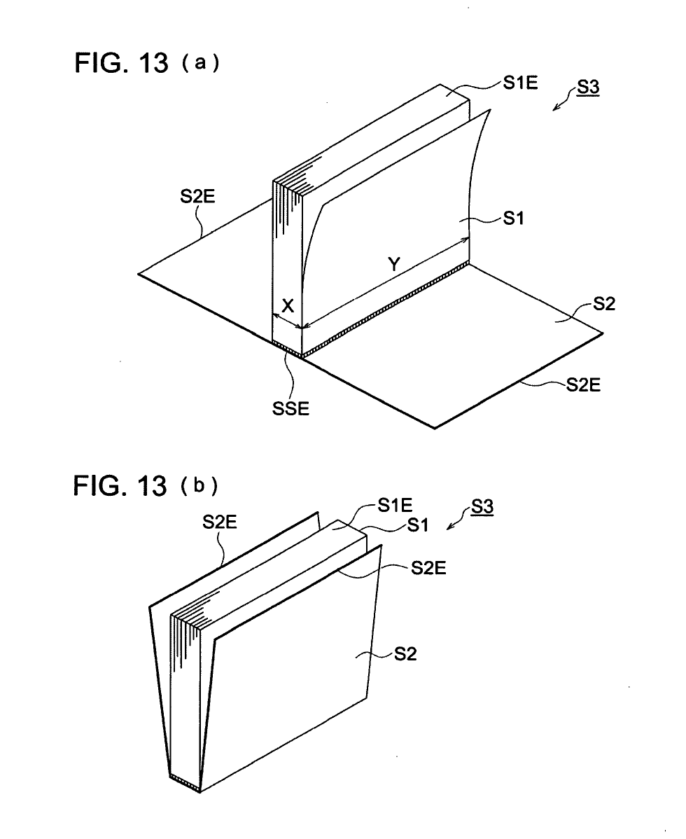

Next, the coating area of adhesive 63 to be applied onto the spine of the bundle of sheets S1 is calculated (step S22 in FIG. 9). This calculation is conducted by image forming apparatus A, based on information of thickness X measured by measuring section 206, received from bookbinding section B. As shown in FIG. 13(a), the coating area of adhesive 63 can be obtained by multiplying thickness X of the bundle of sheets S1 and size Y of sheet S1. Since size Y of sheet S1 can be obtained from attribute information of the printing job, the coating area of adhesive 63 can be obtained by information of size Y, and information of thickness X sent from bookbinding apparatus B.

Next, the coating amount of adhesive 63 is calculated (step S23 in FIG. 9), based on the coating area of adhesive 63, which was calculated in step S22. Since the coating amount of adhesive 63 applied onto a unit area is stored in ROM 102, the coating amount of adhesive 63 can be obtained by multiplying the coating amount of adhesive applied onto a unit area stored in ROM 102, and the coating area of adhesive 63 calculated in step S22.

Based on the coating amount of adhesive 63 calculated in step S23, charge information for adhesive 63 is calculated (step S24 in FIG. 9). Since the charge of adhesive 63 per unit volume is stored in ROM 102, charge information of adhesive 63 (which represents a registration fee of the adhesive for a single booklet) is calculated by multiplying the stored charge of adhesive 63 per unit volume and the coating amount of adhesive 63 which was calculated in step S23. In addition, when the coating amount of adhesive 63 and charge information are calculated in image forming apparatus A, CPU 101 serves as a main section of the calculating section.

In the above case, charge information is calculated based on the coating amount of adhesive 63. Otherwise, it can be directly calculated based on charge information per unit area, stored in ROM 102. That is, the coating amount of adhesive is not used for the calculation.

The coating amount of adhesive 63, which was calculated in step 23, is added to an accumulated value of the adhesive, stored in nonvolatile RAM 104, and charge information of adhesive calculated in step 24 is added to an accumulated value of charge information stored in nonvolatile RAM 104 (step S25 in FIG. 9). In addition, for the adding operation of the accumulated value of the coated amount of adhesive 63, as well as the adding operation of the accumulated value of charge information, CPU 101 works as a main section, which is a first accumulating section.

In the printing job in operation, if a successive booklet is ordered to be outputted (“Yes” of step S26), CPU 101 repeats the operations shown in steps S22-S25.

Further, the operations shown in steps S22-S25 in FIG. 9 are conducted in image forming apparatus A. Otherwise, they can also be conducted in bookbinding apparatus B. In such a case, bookbinding apparatus B receives information of size Y of sheet S1 from image forming apparatus A, so that the operations shown in steps S22-S25 are conducted in bookbinding apparatus B. Yet further, when the coating amount of adhesive 63 and charge information are calculated in bookbinding apparatus B, CPU 201 works as a main section, which is a calculating section. When the accumulated value of the coating amount of adhesive 63, or the accumulated value of charge information is added, CPU 201 serves as the main section, which is a first accumulating section.

FIG. 10 shows an example displayed on operating and displaying section 105 of image forming apparatus A.

The user selects an operation on operating and displaying section 105 of image forming apparatus A, information for using adhesive 63 is then displayed as shown in FIG. 10. Based on the accumulating value of the coating amount of adhesive 63, which was stored in nonvolatile RAM 104, the accumulated consumption of adhesive 63 (which is the accumulated value of coated adhesive 63) is displayed as shown in FIG. 10, and the charge for the accumulated consumption of adhesive 63 (which is the accumulated value of charge information) is displayed as shown in FIG. 10. In addition, when the coating amount of adhesive 63 is calculated in bookbinding apparatus B, the value “the accumulated consumption of adhesive” is displayed on operating and displaying section 205 of bookbinding apparatus B, while using the accumulated value of the coating amount of adhesive stored in nonvolatile RAM 204. Further, “the charge for the accumulated consumption of adhesive” is displayed on operating and displaying section 205 of bookbinding apparatus B, while using the accumulated value of charge information stored in nonvolatile RAM 204.

As detailed by FIGS. 9 and 10, by measuring thickness X of the bundle of sheets S1, and by calculating the coating amount of adhesive and charge information based on the thickness, it is possible to charge an appropriate charge to be levied against the user, or to display the appropriate value (which are coating amount of adhesive and charge information) on operating and displaying section 105.

The operation for accumulating thicknesses X of the outputted bundles of sheets S1 will be detailed, while using the method for directly measuring thickness X of the bundle of sheets S1 which was detailed by FIG. 7 and FIGS. 8(a)-8(d).

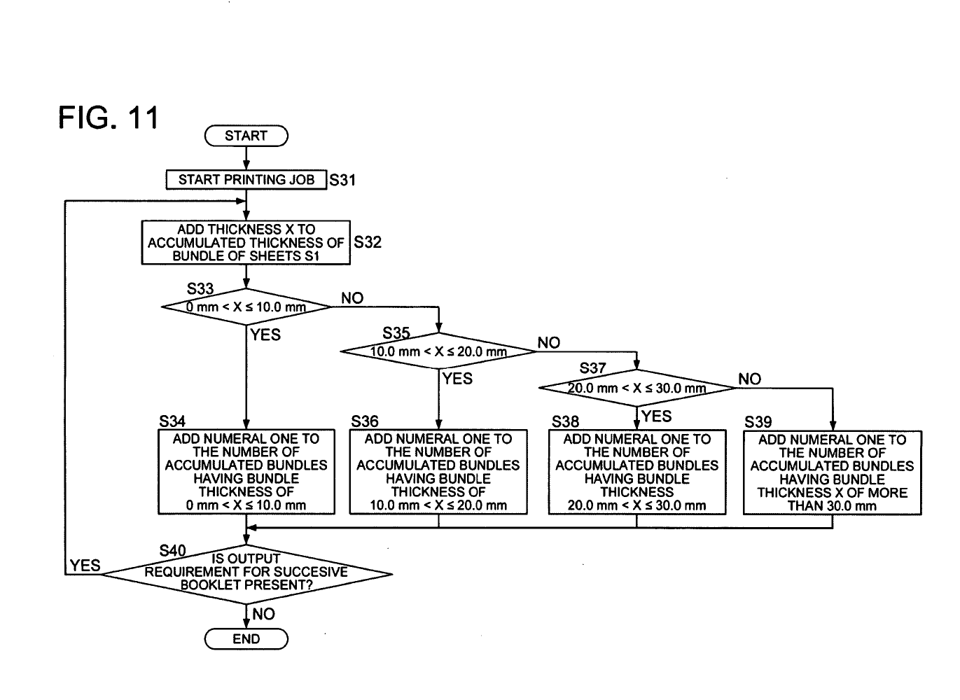

FIG. 11 is a flow chart for accumulating thickness X of the bundles of sheets S1 which are outputted by image forming apparatus A.

Firstly, image forming apparatus A starts a printing job for generating a booklet which was set in operation displaying section 105, or starts a printing job for generating a booklet which was received from the personal computer serving as an external terminal (step S31 in FIG. 11).

After the printing job has started, measuring section 206 measures thickness X of the bundle of sheets S1 which have been stacked on stacking section 50, image forming apparatus A receives the thickness information from booklet binding apparatus B, to enable CPU 101 of image forming apparatus A to add the information for thickness X onto the accumulated thicknesses of the bundles of sheets S1 stored in nonvolatile RAM 104 (step S32 in FIG. 11). That is, the thicknesses of the outputted bundles of sheets S1 are totaled. Due to this procedure, the total thicknesses of the outputted bundles of sheets S1 can be recorded. This operation is conducted within image forming apparatus A, after image forming apparatus A receives information of thickness x measured by measuring section 206, from booklet binding apparatus B.

After the operation of step S32 is completed, a next operation is started in which the number of outputted booklets is totaled for each thickness size of the various bundled sheets of steps S33-S39. Based on information of thickness X measured by measuring section 206 of bookbinding apparatus B, steps S33, S35 and S37 determine a thickness group to which an individual outputted booklet belongs.

When thickness X is greater than 0 mm and not greater than 10.0 mm (“Yes” in step 33), numeral one, as the number of the booklets belonging to the thickness group, is added to the number of those accumulated bundles having the bundle thickness of 0 mm<X≦10.0 mm (step 34).

When thickness X is greater than 10.0 mm and not greater than 20.0 mm (“Yes” in step 35), numeral one, as the number of the booklets belonging to the thickness group, is added to the number of those accumulated bundles having the bundle thickness of 10.0<X≦20.0 mm (step 36).

When thickness X is greater than 20.0 mm and not greater than 30.0 mm (“Yes” in step 37), numeral one, as the number of the booklets belonging to the thickness group, is added to the number of those accumulated bundles having the bundle thickness of 20.0<X≦30.0 mm (step 38).

When thickness X is greater than 30.0 mm (“No” in step 37), numeral one, as the number of the booklets belonging to the thickness group, is added to the number of those accumulated bundles having the bundle thickness greater than 30.0 mm (step 39).

CPU 101 serves as a main section, which is a second accumulating section, to accumulate the total thickness of the outputted sheets bundle in image forming apparatus A, and to accumulate the number of the outputted sheets bundles of each of the various thickness sizes of the sheets bundles.

The value of the accumulated numbers in steps S34, S36, S38 and S39 are stored in nonvolatile RAM 104. In addition, the thickness of the sheets bundle are placed into one of four groups in FIG. 11, which is only an example for this explanation, can also be grouped based on other thickness size, and the numerical values shown in steps S34, S36, S38 and S39 can also be changed to other numerals.

After the addition of the number of accumulated bundles are completed, if the output operation of a successive booklet is required while the printing job is still being conducted (“Yes” in step S40), the operations of steps S32-S40 are repeated.

The operations of steps S33-S39 in FIG. 11 are conducted within image forming apparatus A, but another example is shown in which the operations are conducted within bookbinding apparatus B. In this case, the accumulated thicknesses of the bundles of sheets S1 and the number of accumulated bundles belonging to each thickness group are stored in nonvolatile RAM 204. Further, CPU 201 serves as a main section, which is a second accumulating section, to accumulate the total thickness of the outputted sheets bundle in bookbinding apparatus B, and to accumulate the number of the outputted sheets bundles of each thickness size of the sheets bundles.

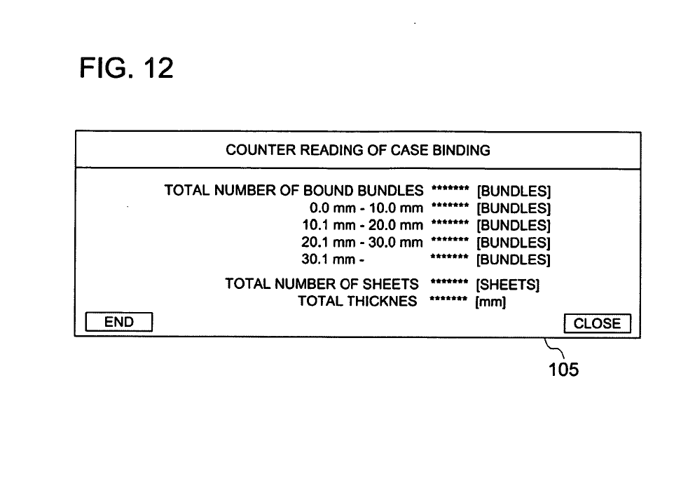

FIG. 12 shows an example, displayed on operating and displaying section 105 of image forming apparatus A.

When the user selects operations on operating and displaying section 105 of image forming apparatus A, a counter reading display for case binding operation is displayed as shown in FIG. 12.

The accumulated thickness of the bundles of sheets S1 (which is the total thickness of the outputted sheets bundle), which has been stored in nonvolatile RAM 104, as explained in step S32 in FIG. 11, is displayed as a “total thickness” at the bottom of operating and displaying section 105. Since the numerical value of the “total thickness” represents an accumulated value of the thicknesses which were correctly measured by measuring section 206 of bookbinding apparatus B, when the user views the numerical value of “total thickness”, the user can see the total value of accumulated thickness X of the sheets bundles representing all the outputted booklets.

Further, the number of the accumulated bundles, which has been stored in nonvolatile RAM 104, as explained in steps S34, S36, S38 and S39 in FIG. 11, is displayed at a central area of operating and displaying section 105. Since the number of accumulated bundles is added based on information, which were correctly measured by measuring section 206 of bookbinding apparatus B, the user can correctly see the number of accumulated bundles for each thickness size of the sheets bundles.

Other than the “total thickness”, the “total number of bound bundles” and the “total number of sheets” are displayed on operating and displaying section 105. The “total number of bound bundles” represents the total number of the booklets outputted by bookbinding apparatus B. When the individual printing job is conducted for producing a booklet, a numerical value is added to this total number, based on the set content of the printing job, which is then stored in nonvolatile RAM 104.

Further, “total number of sheets” represents the total number of the sheets S1 consumed for all the outputted booklets. When the individual printing job is conducted to produce a booklet, a numerical value is added to this total number, based on the set content of the printing job, and which is stored in nonvolatile RAM 104.

Still further, when the total thickness of the bundles of sheets S1 is accumulated in bookbinding apparatus B, the total thickness is displayed on operating and displaying section 205 of bookbinding apparatus B. In this case, operating and displaying section 205 serves as a display section. The total thickness and the number of accumulated bundles for each size are displayed, based on the data stored in nonvolatile RAM 204 of bookbinding apparatus B, and the “total number of bound bundles” and the “total number of sheets” are displayed, based on the data stored in nonvolatile RAM 104 of image forming apparatus A.

The embodiments of the present invention have now been explained. However, the above descriptions in the present embodiments show only an example of the image forming apparatus of the present invention, and descriptions are not limited to this embodiment. These detailed structures and operations of the present embodiments can be appropriately changed within the scope of this invention as long as they do not deviate from the intent of the present invention.

What is claimed is:

1. A bookbinding system comprising:
an image forming apparatus which forms an image on a sheet;
a bookbinding apparatus which forms a sheet bundle by stacking a plurality of sheets on each of which the image has been formed by the image forming apparatus, and joins a spine of the sheet bundle and a cover sheet with an adhesive, thereby produces a booklet;
a coating section which applies the adhesive onto the spine of the sheet bundle;
a measuring section which measures a thickness of the sheet bundle;
a calculating section which calculates at least an amount of the adhesive that has been applied onto the spine of the sheet bundle by the coating section, or charge information corresponding to the amount of the adhesive applied onto the spine, on the basis of thickness information of the sheet bundle measured by the measuring section; and
a first accumulating section which carries out at least an accumulating operation that accumulates the amount of adhesive calculated by the calculating section, or an accumulating operation that accumulates the charge information calculated by the calculating section, when a plurality of booklets are produced.

2. The bookbinding system of claim 1, wherein the calculating section calculates a coating area of the adhesive that has been applied onto the sheet bundle based on the thickness information which has been measured by the measuring section and size information of the sheet constituting the sheet bundle, and calculates at least the amount of adhesive or the charge information based on the coating area.

3. The bookbinding system of claim 1, further comprising a display section which displays an accumulated value of the amount of adhesive accumulated by the first accumulating section or an accumulated value of the charge information.

4. A bookbinding system comprising:
an image forming apparatus which forms an image on a sheet;
a bookbinding apparatus which forms a sheet bundle by stacking a plurality of sheets on each of which the image has been formed by the image forming apparatus, and joins a spine of the sheet bundle and a cover sheet with an adhesive, thereby produces a booklet;
a measuring section which measures a thickness of the sheet bundle; and
a second accumulating section which carries out at least an accumulating operation which accumulates thickness information of the sheet bundle that has been outputted, or an accumulating operation of the number of outputted booklets for each size of thickness, which is classified with respect to the thickness information of the sheet bundle, on the basis of the thickness information measured by measuring section.

5. The bookbinding system of claim 4, further comprising a display section which displays an accumulated value by the second accumulating section.

6. A bookbinding apparatus which produces a booklet by joining a spine of a sheet bundle that are constituted of a plurality of sheets and a cover sheet with an adhesive, the bookbinding apparatus comprising;
a coating section which applies the adhesive onto the spine of the sheet bundle;
a measuring section which measures a thickness of the sheet bundle;
a calculating section which calculates at least an amount of the adhesive that has been applied onto the spine of the sheet bundle by the coating section, or charge information corresponding to the amount of the adhesive applied onto the spine, on the basis of thickness information of the sheet bundle measured by the measuring section; and
a first accumulating section which carries out at least an accumulating operation that accumulates the amount of adhesive calculated by the calculating section, or an accumulating operation that accumulates the charge information calculated by the calculating section, when a plurality of booklets are produced.

7. The bookbinding of claim 6, wherein the calculating section calculates a coating area of the adhesive that has been applied onto the sheet bundle based on the thickness information which has been measured by the measuring section and size information of the sheet constituting the sheet bundle, and calculates at least the amount of adhesive or the charge information based on the coating area.

8. The bookbinding of claim 6, further comprising a display section which displays an accumulated value of the amount of adhesive accumulated by the first accumulating section or an accumulated value of the charge information.

9. A bookbinding apparatus which produces a booklet by joining a spine of a sheet bundle that are constituted of a plurality of sheets and a cover sheet with an adhesive, the bookbinding apparatus comprising;
a measuring section which measures a thickness of the sheet bundle; and
a second accumulating section which carries out at least one of an accumulating operation which accumulates thickness information of the sheet bundle that has been outputted, or an accumulating operation of the number of outputted booklets for each size of thickness, which is classified with respect to the thickness information of the sheet bundle, on the basis of the thickness information measured by measuring section.

10. The bookbinding apparatus of claim 9, further comprising a display section which displays an accumulated value by the second accumulating section.
